(19) United States
(12) Patent Application Publication
(10) Pub. No.: US 2010/0281969 A1
(43) Pub. Date: Nov. 11, 2010

(54) POSITION SENSOR FOR MEASURING THE IDLE STROKE OF A PISTON/CYLINDER SYSTEM

(76) Inventors: Ralf Seidel, Dillenburg (DE); Rolf Franz, Kreuztal (DE)

Correspondence Address: ABELMAN, FRAYNE & SCHWAB, 666 THIRD AVENUE, 10TH FLOOR, NEW YORK, NY, 10017, US

(21) Appl. No.: 12/734,110

(22) PCT Filed: Oct. 1, 2008
(86) PCT No.: PCT/EP2008/008307

§ 371 Date: Jul. 8, 2010

(30) Foreign Application Priority Data
Oct. 10, 2007 (DE) 10 2007 048 686.5

(51) Int. Cl. G01M 19/00

(52) U.S. Cl. 73/168

(57) ABSTRACT

The invention relates a position sensor (1) for measuring the adjustment stroke of a hydraulic piston/cylinder system (3, 4) which acts on the support chock of the rolls (2) of a rolling mill stand, wherein the position sensor (1) is designed to measure a relative displacement between two components (3,4) of the piston/cylinder system (3, 4) in the displacement direction (a) thereof and wherein the position sensor (1) is equipped with a coupling element (5). In order to obtain a simple and compact structure of the coupling element while ensuring high measuring accuracy, the invention provides that the coupling element (5) has a first leaf spring element (6) extending in the displacement direction (a), wherein one end (7) of the first leaf spring element (6) is connected to a first connection member (8) and wherein the other end (9) of the first leaf spring element (6) is connected to an intermediate member (10), and that the coupling element (5) has a second leaf spring element (11) extending in the displacement direction (a), wherein one end (12) of the second leaf spring element (11) is connected to the intermediate member (10) and wherein the other end (13) of the second leaf spring element (11) is connected to a second connection member (14), wherein the planes of the first end and second leaf spring elements (6, 11) are arranged rotatably relative to one another by an angle (a) about the axis of the displacement direction (a).

The invention relates to a position sensor for measuring an adjusting stroke of a hydraulic piston/cylinder system acting on a support chock of a roll of a rolling mill stand, wherein the position sensor is formed for measuring relative displacement of two components of the piston/cylinder system in a displacement direction (a) thereof and wherein the position sensor is provided with a coupling element with which influence of, e.g., tilting movements, which are caused by arching of the roll during rolling operation, can be eliminated.

A position sensor of the type described above is disclosed in EP 1 001 247 A2. It is used in a rolling mill stand of a rolling mill train for rolling, e.g., a strip that should have a predetermined thickness. In order to insure that the roll gap has an exact dimension, its value is monitored by a measurement system. The position sensor has, therefore, a high resolution which permits to carry out a precise measurement of the roll gap. However, tilting movements of the hydraulic cylinder, which are caused, e.g., by arching of the roll during the rolling operation, are very disruptive and influence the measurement results. Therefore, the known solution includes an elastic bar of a certain length and having an elastic region and which is so arranged that the above-mentioned tilting movements only lead to a sidewise camber of the elastic rod which, however, does not influence measurement of an actual roll gap. Thereby, the distortion of the measurement results in counter-acted.

Other solutions are disclosed in FR 2 570 003A, U.S. Pat. No. 5,029,400, EP 1 044 736 B1, EP 0 163 247 A2, DE 35 15 436 A1, DE 196 53 023 A1, and EP 1 420 898 B1 but wherein the above-mentioned problem, however, is not discussed in detail.

Generally, it can be said that for measurement systems in question, different constructive solution for housings of a displacement pick-up are known. For one, a formlocking connection using a spring force is proposed. Further, a formlocking connection is known (see the above-mentioned EP 1 001 274 A2) in which a compensation bar is used. There also exist measurement systems which are arranged directly in the cylinder of a piston/cylinder unit.

Different solutions take into consideration different mounting conditions, stroke, or the necessary precision. The measurement systems are, accordingly, arranged within or outside of the cylinder of the piston/cylinder unit.

With a forcelocking connection, the compensation of the tilting movement is effected with a spring force-driven pressure ram that enables compensation of the mentioned tilting movements (i.e., wobbling) of the cylinder.

With a formlocking connection, the compensation of the tilting movement is carried out using long compensation bars that compensate the tilting movement of the cylinder by elastic deformation of the bar.

The drawback of the forcelocking connection consists in that the inertia of the system prevents a high measurement precision or at least adversely affects it. Further, the limited spring excursion limits the stroke. There is also a danger of jamming of the guide ram which can lead to an error during the displacement measurement. There is also a possibility of an accidental danger resulting from spring preloads during assembly and disassembly. Finally, there is a danger of wear of the spring or the guide elements.

The drawback of the known formlocking connection consists in that a relatively long compensation bar is required which necessitates a large constructional height.

The object of the present invention is to modify the position sensor of the above-discussed type so that the mentioned drawbacks are eliminated. I.e., the position sensor should enable a backlash-free and a wear-free connection of the measurement system at the formlocking connection, wherein, at the same time, a smaller constructional height should be achieved. In particular, the constructional height should be noticeably reduced in comparison with known solutions with a compensation bar, without giving up advantages of this solution.

This object is achieved according to the invention in that the coupling element has at least one first spring element that extends in the displacement direction, wherein one end of the first leaf spring element is connected with a first connection member and another end of the first leaf spring element is connected with an intermediate member; further the coupling element has at least one second leaf spring element that extends in the displacement direction, wherein one end of the second leaf spring element is connected with the intermediate member and another end of the second leaf spring element is connected with the second connection member.

Further, the invention contemplates that planes of the at least one first and the at least one second spring elements are arranged for rotation relative to each other by an angle about an axis of the displacement direction.

The angle between the both planes of both leaf spring elements amounts, preferably, to between 60° and 120°, in particular, advantageously, to 90°.

The intermediate member can be arranged, viewing in the displacement direction, adjacent to or in a region of the second connection member. At that, the first leaf spring element extends linear to a most possible extent and/or is formed as a C-shaped element.

The second leaf spring element is formed as a U-shaped element, wherein ends of legs of the U-shaped structure are arranged on the intermediate member and on the second connection member. According to an alternative advantageous embodiment, the second leaf spring element is formed as a double U-shaped element, wherein ends of legs of the double U-shaped structure are arranged on the intermediate member and on the second connection member.

The intermediate member is advantageously formed as a ring-shaped component.

The mounting of the coupling element is carried out advantageously in direction of the main axis of the piston/cylinder system.

The proposed solution is characterized by the following advantages:

Increase of the measurement precision of the system under the influence of higher dynamic accelerations and is possible even in case of tilting movements (wobbling) of the cylinder. Thereby, a higher operational reliability of the installation is provided for.

As no spring elements are used which are subjected to wear and have a certain inertia, reduction of measurement deviations caused by system itself, becomes possible.

A wear-free connection of the measurement unit to the cylinder is provided for. This results in longer maintenance intervals, which reduces costs. Also, a shorter change time, in case of replacement, is also possible.

Further, accidental danger in comparison with known forcelocking connections of the position sensor is prevented. No spring preload forces need be generated.

The compact construction enables a smaller height of the system and a smaller diameter. Therefore, it is possible to achieve standardization of the sensor housing in the roughing stand or in the finishing train.

The inventive proposal permits to achieve a compact constructional height of the position sensor and, with a formlocking connection of the position sensor (formlocking connection of the measurement system to the movable cylinder for the displacement measurement), forcelocking connection with its above-mentioned drawbacks can be dispensed with.

The drawings show and exemplary embodiment of the invention. It is shown in:

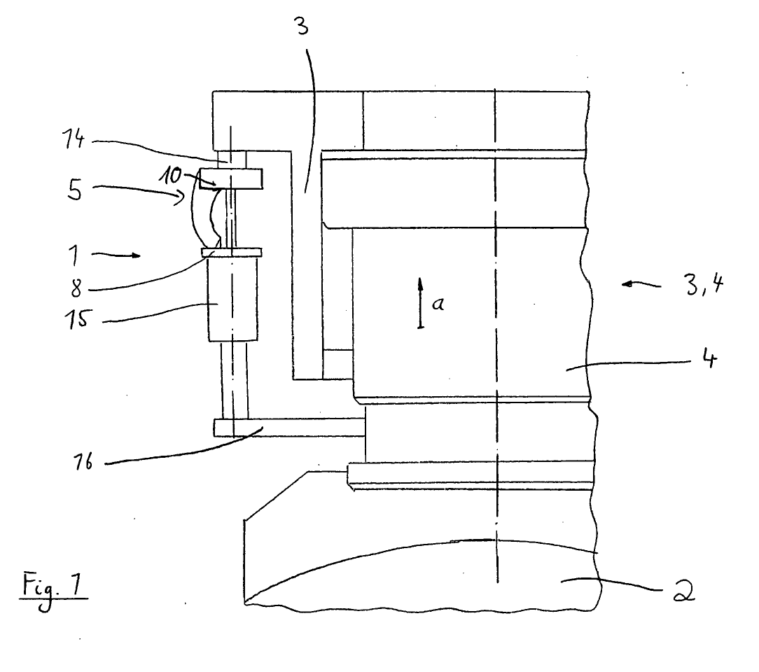

FIG. 1 a schematic side view of a piston-cylinder system for adjusting a roll of a rolling mill stand in a radial direction of the roll and including a position sensor for determining the roll position; and

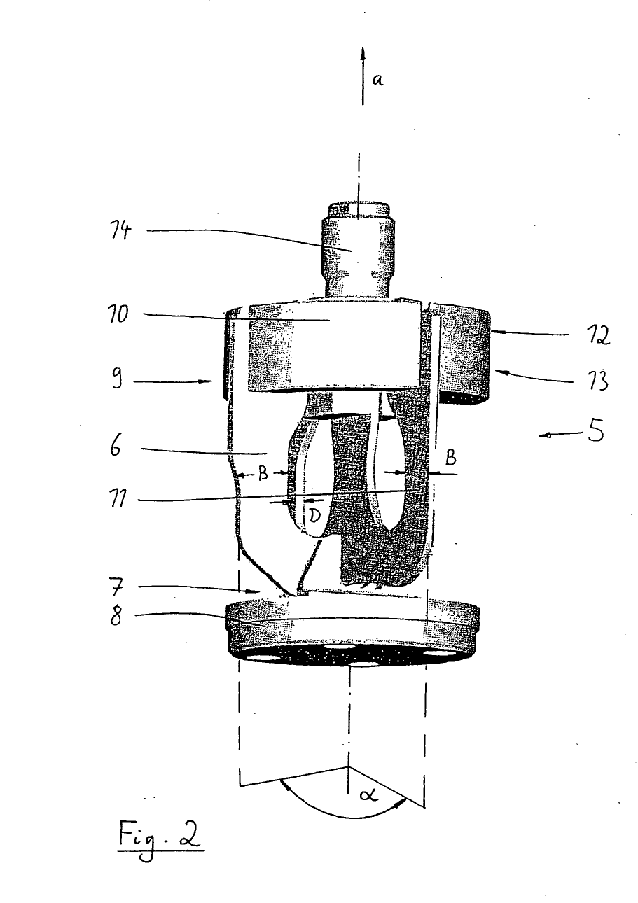

FIG. 2 a perspective view of a coupling element of the position sensor shown in FIG. 1.

In FIG. 1, there is shown a roll 2 of a rolling mill stand with which, e.g., a strip can be rolled. In order to adjust the roll 2 relative to the rolling mill stand to a predetermined roll gap, there is provided a piston-cylinder system 3, 4 that includes a cylinder 3 in which the piston 4 is displaceable. The piston 4 can be displaced in a displacement direction to correspondingly adjust the roll 2.

Because the roll gap should be precisely known, there is provided a position sensor with which a corresponding measurement can be carried out. A connection arm 16 provides for an operative arrangement of the position sensor between the cylinder 3 and the piston 4, so that a relative position of the piston 4 with respect to cylinder 3 can be measured with a displacement pick-up 15. A coupling element 5 connects the displacement pick-up 15 with the cylinder 3. The displacement pick-up 15 should undauntedly transmit the displacement in the displacement direction, compensating, at the same time, the tilting or wobbling movement of the roll 2 and, thus, of the piston 4.

How it is achieved according to a preferred embodiment of the invention is shown in FIG. 2.

The coupling element 5 has two leaf spring elements 6 and 11, namely, a first leaf spring element 6 and a second leaf spring element 11. Both leaf spring elements 6, 11 are formed of a thin spring steel. The width B of the leaf spring elements 6, 11 is noticeably larger than the thickness D of the same.

The coupling element 5 further has a lower, first connection element 8 and a second upper connection element 14. The connection elements 8 and 14 are connected with the displacement pick-up 15 or with cylinder 3, respectively, as can be seen in FIG. 1.

The coupling element 5 further has an intermediate member 10 formed as a relatively large ring.

The first leaf spring element 6 is fixedly connected by its end 7 with the first connection element 8. By its other end 9, the first leaf spring element 6 is fixedly connected with the intermediate member 10.

The second leaf spring 11 is fixedly connected by its end 12 with the intermediate member 10 and by its other end 13 with the second connection element 14.

Both leaf spring elements 6 and 11 are formed, based on thickness and width relationships, flat and even, so that respective planes are defined in which they extend. It is contemplated that the planes of the first and second spring elements 6, 11 are pivotally arranged relative to each other about the axis of the displacement direction a by an angle α.

This means that in the displacement direction a, each movement of the connection element 8 can be transmitted directly and immediately to the connection element 14, whereby a high measurement precision is obtained. Tilting or wobbling movements of the roll 2 or of the piston 4 lead to a deflection transverse to the displacement direction a, which simply causes a sidewise deflection of the leaf spring elements 6, 11 which, thereby, can be compensated without problem by the leaf spring elements 6, 11, without noticeably influencing the measurement results.

The planes of both leaf spring elements 6, 11 a preferably arranged perpendicular to each other (α=90°), so that eventual wobbling movements can be taken up or compensated.

The first leaf spring element 6 extends upright to a most possible extent between the connection member 8 and the intermediate member 10, however, it can easily assume a C-shape (see FIG. 2). The second leaf spring element 11 is formed as a double U-shaped element (see FIG. 2).

This means that the coupling element 5 enables, due to the resulting distribution of forces by the leaf spring elements 6, 11 between both connection members 8 and 14, an axially rigid yet a radially elastic and easily deformable connection.

This results, therefore, in a compact construction of the coupling element 5, which enables a precise measurement in the displacement direction.

### LIST OF REFERENCE NUMERALS

1 position sensor

2 roll

3, 4 piston/cylinder system

3 cylinder

4 piston

5 coupling element

6 first leaf spring element

7 end of the first leaf spring element

8 first connection member

9 end of the first leaf spring element

10 intermediate member

11 second leaf spring element

12 end of the second spring element

13 end of the second spring element

14 second connection member

15 displacement pick-up

16 connection arm

a displacement direction

α angle

B width of the leaf spring elements

D thickness of leaf spring elements

1. A position sensor (1) for measuring an adjusting stroke of a hydraulic piston/cylinder system (3, 4) acting on a support chock of a roll (2) of a rolling mill stand, wherein the position sensor (1) is formed for measuring relative displacement of two components (3, 4) of the piston/cylinder system (3, 4) in a displacement direction (a) thereof and wherein the position sensor (1) is provided with a coupling element with which influence of, e.g., tilting movements, which are caused by arching of the roll during rolling operation, can be eliminated,
characterized in that
the coupling element (5) has at least one first leaf spring element (6) that extends in the displacement direction (a), wherein one end (7) of the first leaf spring element (6) is connected with a first connection member (8) and wherein another end (9) of the first leaf spring element is connected with an intermediate member (10), and the coupling element (5) has at least one second leaf spring element (11) that extends in the displacement direction (a), wherein one end (12) of the second leaf spring element (11) is connected with an intermediate member (10) and wherein another end (13) of the second leaf spring element is connected with a second connection member (14), wherein planes of the at least one first and the at least one second spring elements (6, 11) are arranged for rotation relative to each other by an angle (α) about an axis of the displacement direction (a).

2. A position sensor according to claim 1,
characterized in that
the angle (α) between the both planes of the leaf spring elements (6, 11) amounts to between 60° and 120°.

3. A position sensor according to claim 2,
characterized in that
the angle (α) between both leaf spring elements (6, 11) amounts to 90°.

4. A position according to claim 1,
characterized in that
an intermediate member (10) is arranged, viewing in the displacement direction (a), adjacent to or in a region of the second connection member (14).

5. A position sensor according to claim 4,
characterized in that
the first leaf spring element (6) extends linear to a most possible extent and/or is formed as a C-shaped element.

6. A position sensor according to claim 4,
characterized in that
the second leaf spring element (11) is formed as a U-shaped element, wherein ends of legs of the U-shaped structure are arranged on the intermediate member (10) and on the second connection member (14).

7. A position sensor according to claim 4,
characterized in that
the second leaf spring element (11) is formed as a double U-shaped element, wherein ends of legs of the double U-shaped structure are arranged on the intermediate member (10) and on the second connection member (14).

8. A position sensor according to claim 1,
characterized in that
the intermediate member (10) is formed as a ring-shaped component.
